(19) United States
(12) Patent Application Publication
(10) Pub. No.: US 2014/0251523 A1
(43) Pub. Date: Sep. 11, 2014

(54) LABELING MACHINE AND METHOD FOR LABELING CONTAINERS

(71) Applicant: Krones AG, Neutraubling (DE)

(72) Inventors: Thomas Kellhammer, Bach an der Donau (DE); Robert Giehrl, Wiesent (DE)

(73) Assignee: Krones AG, Neutraubling (DE)

(21) Appl. No.: 14/200,872

(22) Filed: Mar. 7, 2014

(30) Foreign Application Priority Data
Mar. 8, 2013 (DE) 10 2013 102 360.6

(51) Int. Cl. B65C 9/40

(52) U.S. Cl. CPC B65C 9/40
USPC 156/60; 156/349

(57) ABSTRACT

A labeling machine and a method for labeling containers are provided. The labeling machine comprises at least one a labeling module for labeling containers with a label, and a connection device for connecting a labeling module to an electric current line with which electric current can be supplied to the labeling module for operating the labeling module, wherein the connection device it configured such that a data link for transmitting a data signal between the labeling module and the labeling machine is realized via the connection for the electric current line. Alternatively, it is possible, as well, to configure the connection device for transmitting in non-contact a data signal between the labeling module and the labeling machine.

### CROSS-REFERENCE TO RELATED APPLICATION

This application claims foreign priority based on German patent application DE 10 2013 102 360.6, filed on Mar. 8, 2013, the content of which is incorporated herein by reference in its entirety.

### BACKGROUND OF THE INVENTION

1. Field of the Invention

The invention relates to a labeling machine and a method for labeling containers.

2. Description of the Prior Art

A labeling machine is used, for example, in a container treatment plant in the beverage industry. Herein, containers, like bottles, cans, etc. are produced from a preform and/or treated, for example, cleaned, sorted, filled, labeled, etc., such that an end product is provided for a beverage dealer. Hence, a container treatment plant is or comprises in the case of plastic containers a blow molding machine, a cleaning machine, a filling machine, a labeling machine, etc., for example. The container treatment plant can supply electric current to each one of the machines for their drive, in particular by the use of an electric motor. Further, the container treatment plant can supply liquid and/or gaseous media to the machines as needed. There is also a link, for transmitting data signals, between the container treatment plant and its individual machines.

EP 2 060 496 A1 shows a labeling machine for containers, which comprises a blow molding machine having a docking station for a labeling aggregate. With the docking station, a connection is possible to the electric current supply, a link for electric signals or electric data messages and for several media like compressed air, water and the like.

FIG. 9 illustrates a connection device 100 as it is used by the applicant. The connection device 100 is implemented as an electromechanical connector system, wherein different labeling aggregates or labeling modules of the basis machine or main machine of the labeling machine are connected to or disconnected from the basis machine or main machine of the labeling machine, which may be called docking to or undocking from a docking station. Here, connection elements 101 to 104 are provided for connecting an electric current line for the supply of electric current from the main machine to one of the labeling modules. The data link between the main machine and the labeling module is accomplished in FIG. 9 by two data connections 105, 106 comprising connector pins 107 for an Ethernet link, for example.

However, there is a problem in that the connection device 100 is arranged at the labeling machine in a very limited space between two labeling modules. Due to this, there is only a very small space available for the connection device 100. Therefore, there is a need for designing the connection device 100 smaller than hitherto.

A further disadvantage lies in that, in the connection device 100, the electromechanical connector system for the data transmission, which is implemented by Ethernet connector insertions, for example, is system inherently afflicted with wear and is little resistant against contamination.

Problematic is further that the docking station has to provide space for the connection of a plurality of lines. Thereby, the docking station becomes voluminous and bulky on the one hand. On the other hand, the docking station becomes more intricate with every further line to be connected as regards its production. Because of adverse ambient conditions, a seal against the intrusion of dust and/or liquid is to be secured for each line to be connected.

A further problem lies in that the data transmission paths mostly have to comply with a transmission standard for Ethernet of at least the category 5 (CAT5). Since at least the category 5 has to be secured from socket outlet to socket outlet in the most parts and the socket outlet and its installation are the most expensive, they form no negligible cost factor. It is also worth considering realizing the data transmission path with light guides and corresponding connectors. However, this version is generally more costly.

It is further disadvantageous that lines for data transmission are to be installed between the labeling machine and the individual labeling aggregates. In particular, often, long distances are present between a container treatment plant, more precisely, between the control device thereof, and the control device for controlling one of the machines. As regards data lines, a considerable number of lines sums up. In contrast thereto, there is often only very little space for the entire container treatment plant and/or the labeling machine and, thus, for all of its components including the lines, too. Consequently, as the case may be, it is difficult to install the lines in accordance with the installation rules valid in this regard. At that, each line implies a certain fire load which should be as low as possible due to safety reasons.

### SUMMARY OF THE PRESENT INVENTION

Thus, it is an object of the invention to provide a labeling machine and a method for labeling containers with which the above-mentioned problems can be solved. In particular, it should be made possible with the labeling machine and the method that the communication between the control device of the labeling machine and the other components of the labeling machine is made possible reliable, secure and low priced in an as much as possible easy manner and the installation of a link required in this regard is simplified.

The object is solved by a labeling machine comprising at least one labeling module for labeling containers with a label, and a connection device for connecting a labeling module to an electric current line with which electric current can be supplied to the labeling module for operating the labeling module, wherein the connection device it configured such that a data link for transmitting a data signal between the labeling module and the labeling machine is realized via the connection for the electric current line.

With the realization of the data connection in the above-described manner, the connection device and, thus, its housing have smaller space requirements than a conventional connection device. Further, only the current line has to be sealed against the intrusion of dust and/or liquid.

In such a connection device, the system for transmitting electric current and data is less afflicted with wear than in a conventional connection device. Additionally, in the connection device, the system for transmitting electric current and data is more resistant against contamination than in a conventional connection device.

A further advantage of the connection device, results from the fact that the installation of the components necessary for the realization is less intricate. Herein, it is as needed no longer required to provide a separate space for the connection of a data line in the connection device. Thereby, the connection device becomes cheaper in the production. Additionally, the installation and servicing of the labeling machine becomes less intricate and thus cheaper. Should it be, however, sufficient to save only the data line and the necessary socket outlet and to ameliorate the realization of the data link thereby, the powerline modem can however also be integrated into the connection device or can be arranged at the connection device.

In this manner, the above-mentioned problems of the prior art can be solved easily.

Advantageous further developments of the labeling machine are given in the dependent claims.

It is possible that the labeling module is controllable by a labeling module control device for controlling the labeling module and that the data link is provided between the labeling module control device and a main control device of the labeling machine.

According to one embodiment, the labeling module or the connection device might comprise a first powerline modem for modulating the data signal onto the electric current of the current supply or to demodulate the data signal from the electric current of the current supply, and a second powerline modem can be assigned to the main control device to modulate a data signal onto the electric current of the current supply or to demodulate a data signal from the electric current of the current supply.

In addition, the first and the second powerline modems can be connected to a first conductor and the neutral conductor of the electric current supply so that the data signal can be transmitted with the first conductor and the neutral conductor of the electric current supply.

Preferably, the first and second powerline modems each comprise a wired or a wireless interface for the data connection, and/or the first powerline modem provides a connection for a data line to the labeling module control device and the second powerline modem provides a connection for a data line to the main control device.

The above-mentioned object is solved according to a further embodiment by a labeling machine comprising at least one labeling module for labeling containers with a label, and a connection device for connecting a labeling module to an electric current line with which the labeling module can be supplied with electric current for operating the labeling module, wherein the connection device is further configured for transmitting in non-contact a data signal between the labeling module and the labeling machine.

As regards at least the lower space requirements, the lower wear and the resistance against contamination, the connection device and, thus, the labeling machine according to the further embodiment has the same advantages as the above-described connection device and, thus, the labeling machine.

Preferably, the connection device according to the further embodiment is configured for a capacitive transmission of the data signal.

Also in the further embodiment, it is possible that the labeling module is controllable by a labeling module control device for controlling the labeling module, and that the data link is provided between a labeling module control device and a main control device of the labeling machine or the data signal can be transmitted between a labeling module control device and a main control device of the labeling machine.

In the above-described labeling machines, the data signal can be configured according to the transmission protocol of a local network.

In the above-described labeling machines, there is also the possibility that the data signal is configured according to one of the specifications for Ethernet or Token ring or WLAN or Bluetooth.

The above-mentioned connection devices may also comprise a connection unit for connecting at least one medium of a liquid or gaseous medium to the labeling module.

It is possible that the above-mentioned labeling machine is part of a container treatment plant.

The above-mentioned object is further solved by a method for labeling containers by the use of a container treatment plant. The method comprises the steps of: applying a label to a container by a labeling module of a labeling machine, wherein the labeling module comprises a connection device for connecting the labeling module to an electric current line with which electric current is supplied to the labeling module for operating the labeling module, and controlling the application via a data link being for transmitting a data signal between the labeling module and the container treatment plant, wherein the data link is realized via the connection for the electric current line of the connection device or wherein the data signal is transmitted between the labeling module and the labeling machine in non-contact in the connection device.

The method achieves the same advantages as they are mentioned in respect of the labeling machine.

Further possible implementations of the invention comprise also combinations of features or styles described above or in the following with reference to the embodiments, even if they are not explicitly mentioned. Herein, the person skilled in the art will also add single aspects as improvements or additions to the respective basic form of the invention.

### BRIEF DESCRIPTION OF THE DRAWINGS

In the following, the invention is described in more detail by means of embodiments and with reference to the appended drawing Figures, wherein:

FIG. 1 shows a severely simplified top view onto a container treatment plant according to a first embodiment;

FIG. 2 shows a top view onto a connection device of a labeling module according to the first embodiment;

FIG. 3 shows a schematic block diagram of a container treatment plant according to the first embodiment;

FIG. 4 shows a simplified top view onto a powerline modem according to the first embodiment;

FIG. 5 shows a simplified top view onto a powerline modem according to a second embodiment;

FIG. 6 shows a top view onto a connection device according to a third embodiment;

FIG. 7 shows a schematic block diagram of a container treatment plant according to the third embodiment;

FIG. 8 shows a top view onto a connection device of a labeling module according to the third embodiment; and

FIG. 9 shows a top view onto a connection device of a labeling module according to the prior art.

In the figures, the same or functionally same elements are provided with the same reference signs unless given otherwise.

### DETAILED DESCRIPTION OF THE PRESENT INVENTION

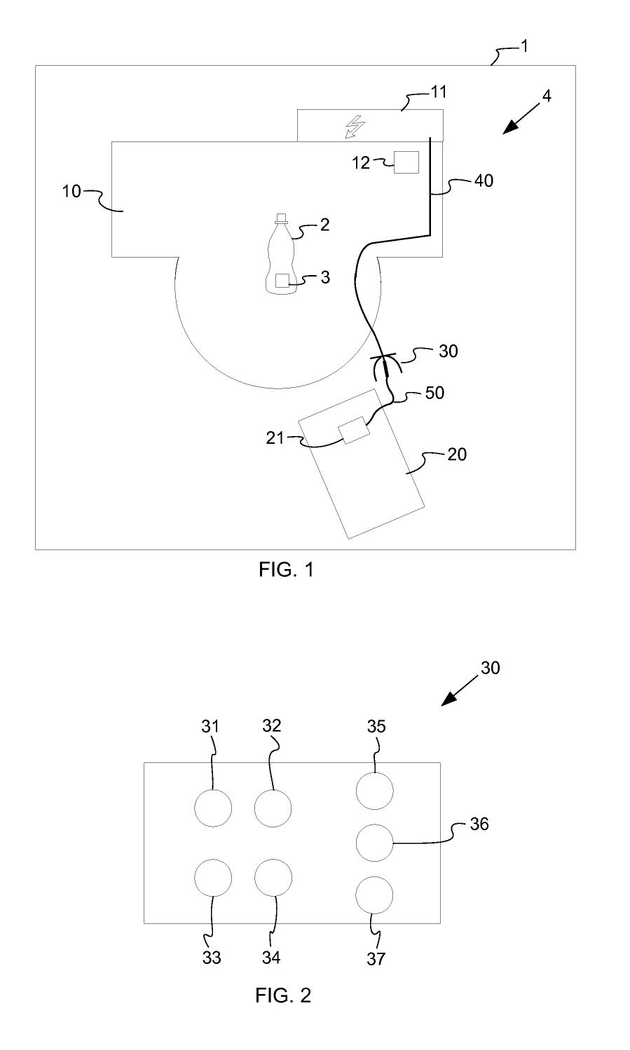

FIG. 1 shows a container treatment plant 1 for treating a container 2. In particular, the container treatment plant 1 serves for labeling the container 2 with a label 3. The container 2 is depicted in FIG. 1 as a bottle. However, the container 2 can also be a can, etc., for example.

The container treatment plant 1 comprises in FIG. 1 a labeling machine 4. The labeling machine 4 has a main machine 10, an electrical cabinet 11, a main control device 12, a labeling aggregate or a labeling module 20, a labeling control device 21, a connection device 30, a link line 40 linking the electrical cabinet 11 and the connection device 30, and a connection line 50 connected to the connection device 30 and the labeling module 20.

In the labeling machine 4, only one labeling module 20 for labeling containers 2 with a label 3 is provided in the present embodiment. However, more than one labeling module 20 can be provided, as well. For a labeling process, the containers 2, which are still to be labeled, are moved past the labeling module 20 with the main machine 10, for example, by the use of a container carousel, such that the labeling module 20 can apply in succession a label 3 to the containers 2.

The labeling machine 4 is controlled by the main control device 12. The labeling module 20 is controlled by the labeling module control device 21. The main control device 12 is superior of the labeling module control device 21. All of the components of the labeling machine 4 are supplied by the electrical cabinet 11 with electric current from an electric energy supplying network, as it is also shown in FIG. 1 by a serrated arrow to the electrical cabinet 11. If the labeling machine 4 comprises more than one labeling module 20 and, thus, more than one labeling module control device 21, the main control device 12 will control the labeling module control device 21 of each of the labeling modules 20.

The link line 40 is installed in FIG. 1 at, in particular inside, the main machine 10. The connection device 30 is arranged at one end of the link line 40. The connection line 50 is plugged into the connection device 30 to connect the labeling module 20 to the connection device 30 and, thus, to the link line 40 and to the electrical cabinet 11. To achieve this, the connection line 50 has at its end, for example, connector elements, which can be plugged into the connection device 30 being implemented as a socket for establishing an electric link. Alternatively, it is also possible that the connection line 50 is implemented at its end as a socket, which can receive connectors of the connection device 30 for establishing an electric link. The connection device 30 and the connection line 50 are thus configured as an electromechanical connector system.

FIG. 2 shows the connection side of the connection device 30 in more detail. Hence, the three phase conductors and the neutral conductor of a rotating current conductor can be connected via connection elements 31, 32, 33, 34 to the connection device 30. Additionally, the connection device 30 comprises at its connection side media connections 35, 36, 37 for connecting of media, which are not shown and which can be used in the operation of the labeling module 20. The media can be liquid and/or gaseous, for example. In particular, compressed air, water, etc. are possible media.

In the connection device 30, the connection elements 31 to 34 do not serve only for the electric energy supply of the labeling module 20. The connection elements 31 to 34 additionally serve for a realization of a transmission of data signals to the labeling module 20 as it is described later in more detail. In contrast thereto, the media contacts 35 to 37 serve as a connection unit for non-electrical media, that is they do not serve as a connection unit for electric current or electric signals.

Consequently, for realizing a transmission of data signals from the main control device 12 and/or the electrical cabinet 11 to the labeling module 20, the connection device 30 according to the present embodiment does not have a separate connection or a connection separated from the electric current supply. The connection device 30 comprises only connections for an electric power supply and a supply with other non-electrical media.

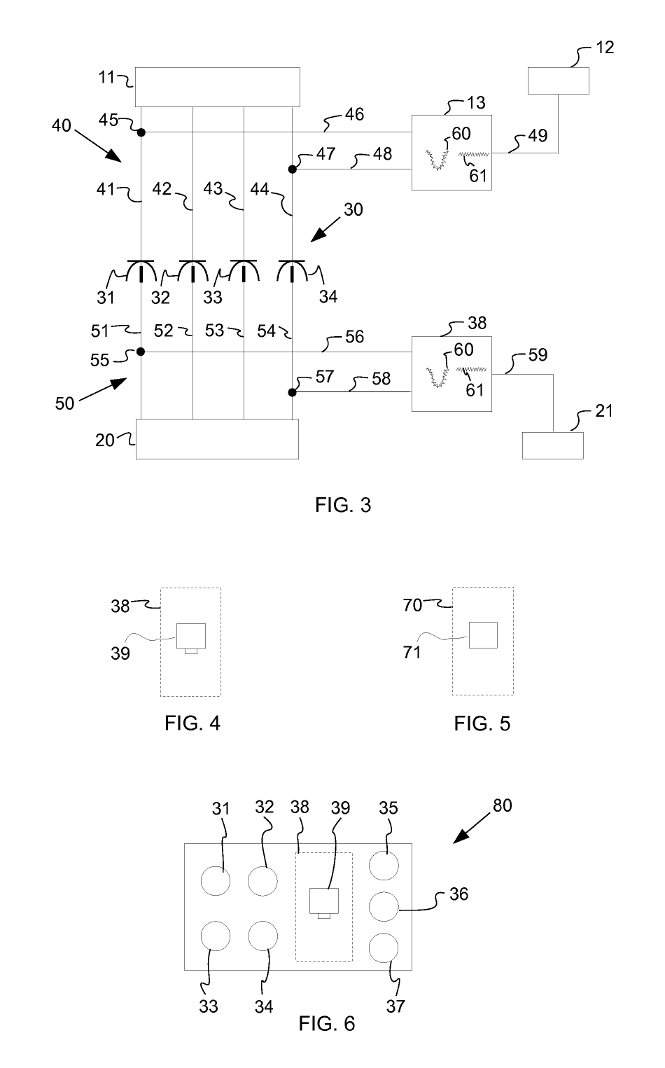

FIG. 3 shows the interconnection of the link line 40 at its one end with the electrical cabinet 11 and the main control device 12 and at its other end with the connection device 30, the labeling module 20 and the labeling module control device 21 at the other side in more detail.

The link line 40 is a line for a three-phase conductor plus a neutral conductor. Hence, the link line 40 comprises a first conductor 41, a second conductor 42, a third conductor 43 and a fourth conductor 44, which is the neutral conductor. The first to third conductors 41, 42, 43 each guide an alternating current being phase-delayed in regard to the other conductors 41, 42, 43. The first conductor 41 is connected to the socket of the first connection element 31. The second conductor 42 is connected to the socket of the second connection element 32. The third conductor 43 is connected to the socket of the third connection element 33. The fourth conductor 44 is connected to the socket of the fourth connection element 34.

Thus, also the connection line 50 is a line for a three-phase conductor plus a neutral conductor. Herein, a first connection conductor 51 is plugged into the socket of the first connection element 31 and is thus connected to the first conductor 41. A second connection conductor 52 is plugged into the socket of the second connection element 32 and is thus connected to the second conductor 42. A third connection conductor 53 is plugged into the socket of the third connection element 33 and is thus connected to the third conductor 43. A fourth connection conductor 54 is plugged into the socket of the fourth connection element 34 and is thus connected to the fourth conductor 44, the neutral conductor. At its other end, the connection conductors 51, 52, 53, 54, are connected to the labeling module 20. In this manner, a driving motor of the labeling module 20, which is not shown, can be supplied with electric current from the electrical cabinet 11, such that operating the labeling module 20 is possible. In addition thereto, the driving motor of the labeling module 20 can be controlled by the labeling module control device 21 by a presetting of the main control device 12 in the form of a data signal or a control signal.

From the first conductor 41, a first branch line 46 branches at a first node 45 and guides to a first powerline modem 13. Further, a second branch line 48 branches from the fourth conductor 44, the neutral conductor, at a second node 47, which second branch line 48 leads to the powerline modem 13, as well. In the powerline modem 13, the electric current 60 transmitted by the branch lines 46, 48 is demodulated so that, by the use of the powerline modem 13, a data signal 61 is filtered out which is modulated onto the electric current 62. The data signal 61 can be supplied by the powerline modem 13 to the main control device 12 via a first control signal link 49. Vice versa, the main control device 12 can send a data signal 61 to the powerline modem 13 via the first control signal link 49. In this case, the powerline modem 13 modulates the data signal 61 onto the current 60 in the first conductor 41 and the fourth conductor 44, the neutral conductor, so that the modulated electric current 60 is the result.

To transmit the data signal 61 to the labeling module control device 21, a third branch line 56 branches from the first connection conductor 51 at a third node 55, and from the fourth connection conductor 54, the neutral conductor, branches a fourth branch line 58 at a fourth node 57. The branch lines 58 lead to a second powerline modem 38. The powerline modem 38 operates similar to the first powerline modem 13. Hence, the powerline modem 38 modulates the data signal 61 onto the electric current 60 in the connection conductors 51, 54, or demodulates the data signal 61 from the electric current 60. As a result, the data signal 61 can be transmitted by the use of a second control signal link 59 from the powerline modem 38 to the labeling module control device 21. Likewise, the labeling module control device 21 can transmit by the use of the control signal link 59, a data signal 61 to the powerline modem 38, so that it is modulated onto the electric current 60 as a signal, and then, can be sent in the direction of the main control device 12, as described above.

Thus, the link line 40 and the connection line 50, or more precisely its conductors 41, 44, 51, 54, form an electric current line which is used for the guidance of an electric current between the electrical cabinet 11 and the labeling module 20 for the power supply of the labeling module 20, too. Further, the branch lines 46, 48, 56, 58 are to be designed accordingly that they are suitable for the guidance of the electric current 60 including the data signal 61. The branch lines 46, 48, 56, 58 are part of the electric current line which provides the data link between the labeling machine 4 or the container treatment plant 1 and the labeling module 20.

The electrical cabinet 11 is supplied by a rotating current system that has an electric voltage in a range of, for example, about 220/380 V to about 230/400 V and a frequency in a range of, for example, about 50 Hz to about 60 Hz. However, other voltages and/or frequencies are conceivable, as well. An electric current corresponding thereto flows in the link line 40 and the connection line 50.

The frequency of the data signal 61 can be, in particular, in a range of 20 to 300 kHz. The first and second powerline modem 13, 38 are configured such that they determine the frequency of the data signal 61 to a frequency which does not disturb the operation of other electric apparatuses of the container treatment plant 1 and, thus, the labeling machine 4. A filter which is not shown and which can be in the form of a band pass filter or a low pass filter can be provided in the electrical cabinet 11 and/or in the labeling module 20. With the filter, the data signal 61 can be filtered out of the electric current 60. Thus, the data signal, cannot disturb the operation of the electrical cabinet 11 and/or the labeling module 20.

As depicted in FIG. 3, only the first and second branch lines 45, 46, branch from the link line 40 between the electrical cabinet 11 and the connection device 30. In particular, other electrical apparatuses are integrated into the system shown in FIG. 3 only such that they cannot disturb the communication between the first and second powerline modems 13, 38. Thus, no other electrical apparatuses are connected between the first and second powerline modems 13, 38.

In the present embodiment, the powerline modem 38 is not included in the connection device 30. Because of this, no data line has to be inserted into the connection device 30 and to be sealed against dust and/or liquid. In contrast thereto, the powerline modem 38 is arranged directly at the labeling module control device 21, for example. In this case, the control signal link 59 is designed very short in comparison to the branch lines 55, 56. This is very advantageous, if the control signal links 49, 59, are more expensive than the branch lines 46, 48, 56, 58. In a similar way, the powerline modem 13 is arranged favorably directly at the labeling module control device 21.

FIG. 4 shows very schematically a possible configuration of the powerline modem 38 according to this embodiment. Herein, the powerline modem 38 comprises a wired connection unit 39 for a wired data network, in particular a local network, like for example Ethernet, Token Ring, etc. The connection unit 39 is implemented in FIG. 4 as an example in form of a RJ-45-socket with which a connection to a data network can be accomplished. The control signal links 49, 59, have, thus, at their one end a RJ-45-connector fitting into the RJ-45-socket. The powerline modem 13 can be implemented in the same way with a connection unit 39, even if this is not depicted in the drawings. In any case, the first and second powerline modems 13, 38 each comprises with the connection unit 39 a wired interface for a data bus system or a data network like a local network (LAN), a wide area network (WAN), etc. The data signal 61 configured according to such a standard or specification is thus transmitted wired along the data transmission path of the first and second control signal links 49, 59.

FIG. 5 shows very schematically a possible configuration of a powerline modem 70 according to a second embodiment. The powerline modem 70 may be used instead of the first or the second powerline modem 13, 38. Apart from that, the container treatment plant 1 is configured in the present embodiment like it is shown in FIG. 1 to FIG. 3, so that they are not shown and described here again.

In FIG. 5, the powerline modem 70 is provided with a radio unit 71 for a wireless communication with the respective control device 13, 38. Herein, the main control device 12 communicates with a powerline modem 70 and the labeling module control device 21 communicates with a further powerline modem 70. The radio unit 71 thus enables a wireless connection by the use of, for example, the standards or specifications for WLAN (Wireless Local Area Network), Bluetooth or via infrared or another wireless data transmission standard. The data signal 61 configured according to such a standard or such a specification is thus transmitted via radio and wirelessly along the data transmission path of the first and second control signal links 49, 59. Also therewith, the powerline modems 70 used as the first and second powerline modems, each comprises, because of the radio unit 71, an interface for a data bus system or a data network, namely a wireless local network.

FIG. 6 shows a connection device 80, which can be used according to a third embodiment in the container treatment plant 1. The container treatment plant 1 is configured as shown in FIG. 1, so that it is not shown and described here again.

In the present embodiment, the connection device 80 comprises the powerline modem 38. The connection device 80 comprises further again the media connections 31 to 37 like in the connection device 30 of the first embodiment. Hereby, the connection device 80 is indeed larger than the connection device 30 of the first or second embodiment. The connection technique for the data technique, however, is much easier because of the powerline modem 38 than in a conventional connection device. Further, the data line along the main machine 10 (FIG. 1) is saved. Therewith, and because of the omission of the installation which was required in this regard hitherto, the costs are nevertheless lower compared to the prior art.

In the connection device 80, the connectors 31 to 34 serve, like in the connection device 30 of the first embodiment, for the electric energy supply of the labeling module 20. Additionally, the media connections 35 to 37 serve again as connection unit for physical or non-electrical media. In contrast thereto, the powerline modem 38 and the connection element 39 serve for realizing a transmission of data signals 61 to the labeling module 20.

As an alternative to the powerline modem 38, also the powerline modem 70 according to the second embodiment may be part of the connection device 80. The powerline modem 13 is designed analogously to the powerline modem on the side of the labeling module 20 or its control device 21. Thereby, the transmission of the data signal 61, between the powerline modems and the control devices 12, 21, can be secured according to only one data transmission standard. In this case, the conversion of the data signal 61 into another standard is not required.

According to a further alternative, the powerline modem 38 or 70 may be arranged otherwise at the connection device 80 than it is shown in FIG. 6. It will be however advantageous, if the powerline modem 38 or 70 is arranged such that the branch lines 55, 56 are as short as possible.

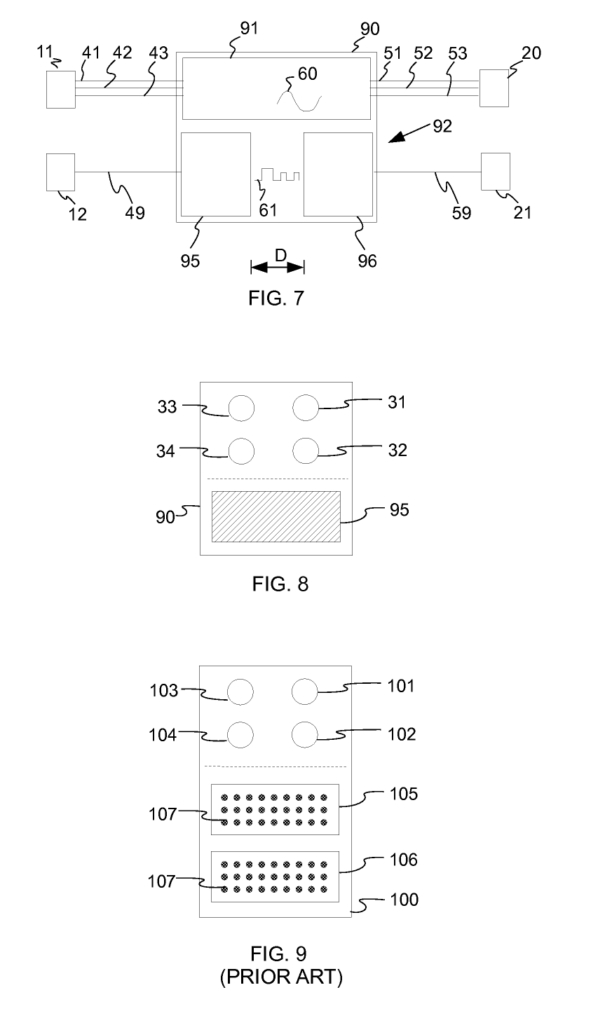

FIG. 7 illustrates in a schematic block diagram a third embodiment for linking the electrical cabinet 11 and the main control device 12 to the labeling module 20 and the labeling module control device 21 of the container treatment plant 1. In this case, a link 91 is implemented as an electromechanical connector system and serves for transmitting the electric current 60. In contrast thereto, a link 92 in the connection device 90 is configured contactless or wireless and serves as a data link. For the implementation of the coupling, the link 92 comprises a first transmitter 95 and a second transmitter 96 in this regard. Between the first and second transmitter 95, 96 is provided a distance D having such a dimension that a secure transmission of the data signal 61 via the contactless link is secured. Thus, the data transmission and the power transmission are effected separately in the present embodiment.

The link 91 is arranged at one end of the first to third conductors 41 to 43 and at one end of the first to third connection conductors 51 to 53. The link 92 is arranged at one end of the first and second control signal links 49, 59, respectively. Thereby, the connection device 90 is connected at one side to the electrical cabinet 11 and the main control device 12. At the other side, the connection device 90 is connected to the labeling module 20 and the labeling module control device 21.

In FIG. 7 the first to third conductors 41 to 43 form the link line 40. The first to third conductors 41, 42, 43 each guide an alternating current being phase-delayed in respect to the other conductors 41, 42, 43. The neutral conductor is not shown here for the sake of convenience. Further, the first to third connection conductors 51 to 53 form the connection line 50. The first to third connection conductors 51 to 53 each guide again the alternating current being phase-delayed in respect to the other connection conductors 51 to 53. Also here, the neutral conductor is not shown for the sake of convenience.

In the present embodiment, the link 92, and thus the connection device 90, performs a capacitive transmission of the data signal 61 from the first transmitter 95 to the second transmitter 96 or vice versa. Herein, the data transmission is performed as a capacitive transmission in the near field, whereby external interference fields may not have an influence. Consequently, the error rate is very low.

Since the first and second transmitters 95, 96 do not contact each other, the transmission is contactless. The capacitive transmission of the data signal 61 takes place by the use of electrical conductive planes of the first and second transmitters 95, 96.

With the connection device 90, transmission rates up to 10 gigabit/s are possible. Transmission rates up to >40 gigabit/s are possible in parallel circuit. Therewith, the standards or specifications for the transmission rate of, for example, 10 megabit/s for Ethernet, 100 megabit/s for fast Ethernet, 1000 megabit/s for gigabit-Ethernet etc., may be achieved.

FIG. 8 depicts the connection device 90 in a top view onto the transmitter 95 at the side which serves for transmitting the electric current 60 and the data signal 61 to the side of the connection device 90 having the second transmitter 96. The side of the connection device 90 having the second transmitter 96 is not shown here, however, is implemented in the same manner as shown in FIG. 8.

In FIG. 8, the connection device 90 comprises besides the connector pins or sockets 31 to 34 only the plane of the first transmitter 95, which is required for the transmission of the data signal 61 to the second transmitter 96. The link 92 of the connection device 90 has, thus, no connector pins and therefor no sockets for receiving connector pins, too. The plane of the first transmitter 95, which is faced to the plane of the second transmitter 96, can be a plane being essentially even. The plane of the second transmitter 96, which is faced to the plane of the first transmitter 95, is preferably formed complementary to the plane of the first transmitter 95. As needed, the plane for the transmitter 95, which is shown in FIG. 8, may also be formed smaller than shown, so that the entire connection device 90 and, thus, also its housing is as small as possible.

Even if the contactless data transmission in the third embodiment is preferably effected as a capacitive transmission, the contactless data transmission can be implemented as an alternative thereto also optical by high frequency, inductive and advantageously without protocol.

Additionally, a real-time Ethernet bus can be realized by the connection device 90, so that all of the measurement values occurring in the entire system can be detected and processed with chronological synchronism and with high data security.

According to a modification of the third embodiment, also the electric current 60 can be transmitted in non-contact in the connection device 90. In this case, the electric current 60 is transmitted inductively, for example by the use of coils and the data signal 61 is transmitted in a capacitive transmission.

According to a further modification of the third embodiment, the electric current 60 and the data signal 61 can be transmitted at least in in sections over two different channels of the link line 40 and/or the connection line 50. Thereupon, the electric current 60 and the data signal 61 can be transmitted separately between the first and the second transmitters 95, 96, as described above in respect of the third embodiment. The two channels can be realized either by one of the first to third conductors 41 to 43 or by two of the first to third conductors 41 to 43. In the latter case, the data signal 61 would be transmitted in parallel by two conductors. The electric current 60 and the data signal 61 are thus transmitted via two different channels of the connection line 50, as well. The two channels may be realized either by one of the first to third connection conductors 51 to 53 or by two connection conductors of the first to third connection conductors 51 to 53.

According to still another modification of the third embodiment, the data signal 61 might also be modulated onto the electric current 60 or demodulated therefrom. In this case, the data signal 61 would be transmitted in non-contact together with the electric current 60 in the connection device 90.

The third embodiment and the modifications thereof are in particular preferable, if the connection device 90 is to be arranged in a labeling machine in a very limited space between two labeling modules and, thus, only very little space is available for the connection device 90.

The connection device 90 according to the third embodiment and the modifications thereof, further provides the advantage, that it is, due to the missing electromechanical connector system for data transmission, due to the system very little afflicted to wear and very resistant against contamination.

All of the above-described implementations of the container treatment plant 1, the labeling machine 4 and the method can be used separately or in all possible combinations thereof. In addition, in particular, the following modifications are conceivable.

The elements shown in the figures are depicted schematically and can differ in the specific implementation from the forms shown in the figures provided that the above-described functions are ensured.

The container treatment plant 1 can comprise in the case of containers 2 made of plastics besides the labeling machine 4, for example, a blow molding machine comprising an upstream heating device, a cleaning machine, a filling machine, etc. In the case of containers 2 made of glass, the blow molding machine comprising an upstream heating device may be omitted.

The basic signal form of the electric current signal 60, onto which the data signal 61 is or will be modulated, can have another signal form than a sinus form or cosines form. Any other possible signal form is conceivable, which complies with the above-described functions of the invention.

Further, also the data signal 61 can have another signal form than a rectangle form or a sinus form or a cosines form. Any other possible signal form is conceivable, which complies with the above-described functions of the invention.

It is not obligatory that the connection unit 39 is implemented in the form of a RJ-45-socket, as described in respect of FIG. 4. The connection unit 39 might also have another implementation form as long as it is suitable for the above-described function. For example, also the implementation of the connection unit 39 as a USB-interface (USB=universal serial bus) is possible, so that at least one of the control signal links 49, 59, is formed at its end suitable for the USB-interface.

The powerline modem 70 of FIG. 5 may comprise, besides the radio unit 71, for a wireless communication with the control devices 13, 38, respectively, in addition at least one connection unit 39, also for a wireless communication, as described in respect of FIG. 4 and above. In this case, still further devices in addition to the control devices 12, 21 can be connected to the powerline modem 70.

Also the connection device 90 according to the third embodiment can comprise the media connections 35 to 37 as connection unit for physical or non-electrical media.

What is claimed is:

1. A labeling machine, comprising
at least one labeling module for labeling containers with a label, and
a connection device for connecting a labeling module to an electric current line with which electric current can be supplied to the labeling module for operating the labeling module,
wherein the connection device it configured such that a data link for transmitting a data signal between the labeling module and the labeling machine is realized via the connection for the electric current line.

2. The labeling machine according to claim 1,
wherein the labeling module is controllable by a labeling module control device for controlling the labeling module, and
wherein the data link is provided between the labeling module control device and a main control device of the labeling machine.

3. The labeling machine according to claim 2,
wherein the labeling module or the connection device comprises a first powerline modem for modulating the data signal onto the electric current of the current supply or to demodulate the data signal from the electric current of the current supply, and
wherein a second powerline modem is assigned to the main control device to modulate a data signal onto the electric current of the current supply or to demodulate a data signal from the electric current of the current supply.

4. The labeling machine according to claim 3, wherein the first and the second powerline modems are connected to a first conductor and the neutral conductor of the electric current supply, so that the data signal can be transmitted with the first conductor and the neutral conductor.

5. The labeling machine according to claim 3,
wherein the first and second powerline modems each comprise a wired or a wireless interface for the data connection, or
wherein the first powerline modem provides a connection for a data line to the labeling module control device and the second powerline modem provides a connection for a data line to the main control device.

6. A labeling machine, comprising
at least one labeling module for labeling containers with a label, and
a connection device for connecting a labeling module to an electric current line with which the labeling module can be supplied with electric current for operating the labeling module,
wherein the connection device is further configured for transmitting in non-contact a data signal between the labeling module and the labeling machine.

7. The labeling machine according to claim 6, wherein the connection device is configured for a capacitive transmission of the data signal.

8. The labeling machine according to claim 6 or 7,
wherein the labeling module is controllable by a labeling module control device for controlling the labeling module, and
wherein the data signal can be transmitted between a labeling module control device and a main control device of the labeling machine.

9. The labeling machine according to claim 1 or 6, wherein the data signal is configured according to the transmission protocol of a local network.

10. The labeling machine according to claim 1 or 6, wherein the data signal is configured according to one of the specifications for Ethernet or Token ring or WLAN or Bluetooth.

11. The labeling machine according to claim 1 or 6, wherein the connection device further comprises a connection unit for connecting at least one medium of a liquid or gaseous medium to the labeling module.

12. A container treatment plant, comprising
a labeling machine according to claim 1 or 6.

13. A method for labeling containers, the method comprising the steps of:
applying a label to a container by a labeling module of a labeling machine, wherein the labeling module comprises a connection device for connecting the labeling module to an electric current line with which electric current is supplied to the labeling module for operating the labeling module, and
controlling the application via a data link being for transmitting a data signal between the labeling module and the container treatment plant,
wherein the data link is realized via the connection for the electric current line of the connection device, or
wherein the data signal is transmitted between the labeling module and the labeling machine in non-contact in the connection device.
